(19) United States
(12) Patent Application Publication
(10) Pub. No.: US 2005/0077212 A1
(43) Pub. Date: Apr. 14, 2005

(54) Separating machine

(76) Inventors: Jesse Jewell Prince, Gainesville, GA (US); Prentiss Clay Hamilton, Atlanta, GA (US); Kam Singh, Gainesville, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/683,850

(22) Filed: Oct. 10, 2003

(51) Int. Cl. B07B 1/20

(52) U.S. Cl. 209/305; 209/300

(57) ABSTRACT

Machines, methods and devices for separating hard material from soft material are disclosed. The machine includes a conduit and an inlet tube connected to the conduit for providing the conduit with hard and soft material. A separating apparatus is positioned at one end of the conduit. The separating apparatus comprises a wall having an interior side and an exterior side and a plurality of apertures through the wall, each aperture comprising an outer section and an inner section, the outer section having a first opening and the inner section having a plurality of second openings, wherein the second openings open from the interior side to the first opening and the first opening opens to the exterior side. A device is used for moving the hard and soft material along the conduit from the inlet tube to the screen end of the conduit so that soft material and a controlled amount of hard material are forced through the apertures in the separating apparatus.

### FIELD OF THE INVENTION

This invention relates to machinery for the separation of hard and soft materials of land and sea animals, vegetables, fruits, etc., and, in particular, it relates to separating apparatuses through which the soft material is forced and from which the hard material is separated.

### BACKGROUND OF THE INVENTION

Machines are well known for separating soft from hard material of land and sea animals, vegetables, fruits, etc. utilizing an auger compression or other means, such as pistons, belts, or the like, through a separating apparatus, such as a screen or sieve. Screens are perforated structures that surround an auger or like device and are generally tubular. For example, as the material enters the separating machine, the auger forces the material to build up in the area of the screen. As the pressure and material build up, the soft material is forced through the screen, and the hard material does not or does so only in very small controlled quantities. Sieves are perforated structures that are used with a piston or like device. With a piston-based separating machine, the piston forces hard and soft material to a sieve where soft material is forced out through the sieve.

A balance must be struck when using a separating machine between the throughput of the soft material through the separating apparatus, the ability of the separating apparatus to reduce the amount of hard material through the separating apparatus, and the amount of friction caused by the separating apparatus and consequent temperature rise caused by the friction. When using such machines to separate meat from bone, certain governmental regulations restrict the amount of bone in the separated meat. Consumers of the resulting soft material processed by separating machines generally do not want perceptible hard material in the soft material.

Conventional screens or sieves are typically fabricated in one of three methods. In a first fabrication technique, a length of pipe is drilled with various hole sizes using readily available drilling machines. Due to the diameter of the holes needed to prevent throughput of hard material these screens typically have a slower throughput of soft material and friction between the material and the screen can become a problem. In a second conventional technique, generally circular plates are machined to produce areas of reduced thickness, and the plates are stacked to produce a generally tubular structure having slots passing through the tube wall corresponding to the machined areas of the plates. In a third structure, plates are fabricated as described above, stacked, and then welded together. The second and third structures are typically expensive to manufacture and can be costly to maintain.

### SUMMARY OF THE INVENTION

Machines, methods and apparatuses for separating hard material from soft material that provide a balance sought in separating machines are disclosed. The machine includes a conduit and an inlet tube connected to the conduit for providing the conduit with hard and soft material. A separating apparatus is positioned at one end of the conduit. The separating apparatus comprises a wall having an interior side and an exterior side and a plurality of apertures through the wall, each aperture comprising an outer section and an inner section, the outer section having a first opening and the inner section having a plurality of second openings, wherein the second openings open from the interior side to the first opening and the first opening opens to the exterior side. A device is used for moving the hard and soft material along the conduit from the inlet tube to the separating apparatus end of the conduit so that soft material and a controlled amount of hard material are forced through the apertures in the separating apparatus. The machines, methods and devices of the present invention increase the throughput of the soft material through the separating apparatus, while providing a balance between the ability of the separating apparatus to reduce the amount of hard material through the separating apparatus, and the amount of friction caused by the separating apparatus and consequent temperature rise caused by the friction.

### BRIEF DESCRIPTION OF THE DRAWINGS

FIG. 1 is perspective view of an embodiment of a separating apparatus of the present invention.

FIG. 2 illustrates a portion of the separating apparatus from the exterior of the separating apparatus.

FIG. 3 illustrates a portion of the separating apparatus from the interior of the separating apparatus.

FIG. 4 illustrates a cut away view of an aperture of the separating apparatus.

FIG. 5 illustrates an alternate embodiment of the separating apparatus.

FIG. 6 illustrates an alternative embodiment of the separating apparatus.

FIG. 7 illustrates an alternative embodiment of the separating apparatus.

FIG. 8 illustrates a separating machine of the present invention.

### DETAILED DESCRIPTION

The present invention comprises machines, methods and apparatuses for separating hard material from soft material. Reference will now be made in detail to exemplary embodiments of the invention as illustrated in the text and accompanying drawings. Those skilled in the art will recognize that many other implementations are possible, consistent with the present invention. The same reference numbers are used throughout the drawings and the following description to refer to the same or like parts. While the exemplary embodiments discuss the use of a screen as the separating apparatus, one skilled in the art would appreciate that the separating apparatus could be configured differently, such as a sieve, for example.

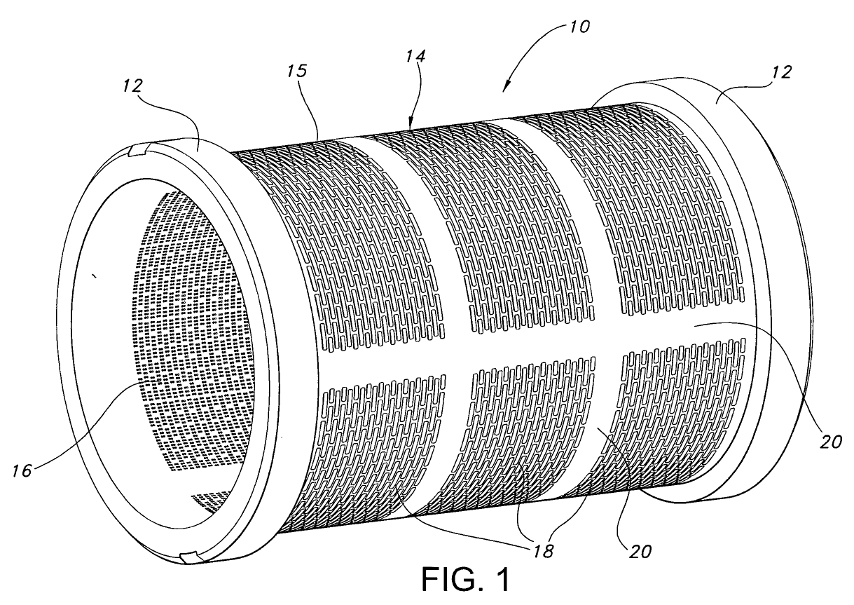

FIGS. 1-4 illustrate one embodiment of a screen 10 of this invention. As shown in FIG. 1, the screen structure 10 is generally cylindrical in shape having two end portions 12 and a wall portion 14. The screen 10 could also have a variety of cross sections, such as rectangular, hexagonal or oval. The wall portion 14 has an exterior side 15 and an interior side 16 and includes a plurality of apertures 18 providing openings between the sides. The apertures 18 are oriented generally parallel to the major axis of the screen 10. As shown in FIG. 1, the wall portion 14 includes ribs 20 that operate to reinforce the wall portion 14. One skilled in the art would appreciate that the ribs 20 are not necessary depending on the strength of material used to manufacture the screen. The screen is manufactured from any material capable of withstanding the pressures of the separation process known to those skilled in the art. Such materials include steel, ceramic and plastic. Typically, the screen can vary in length from two inches to fifteen inches and for a five inch long screen, for example, have an inside diameter of 4.88 inches. These dimensions are exemplary and one skilled in the art would know that these dimensions can vary depending on the separation machine.

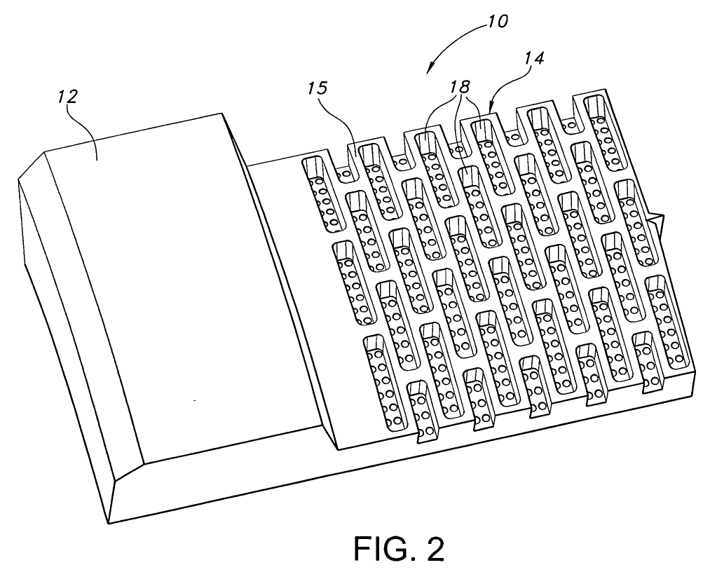

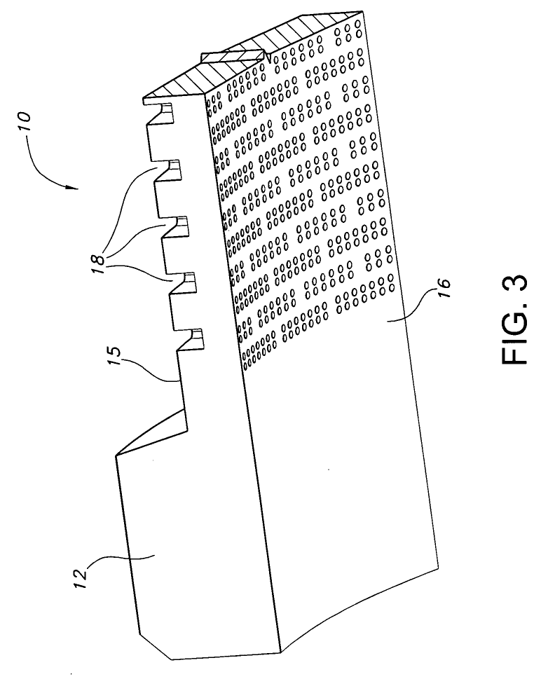

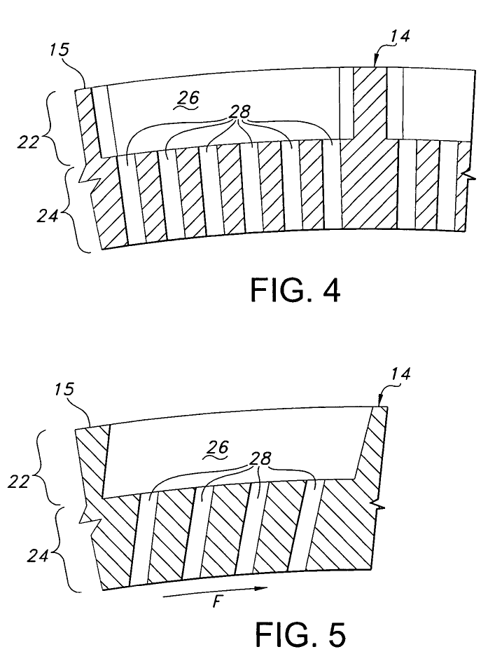

As can be seen in FIGS. 2-3 and in more detail in FIG. 4, the apertures 18 include an outer section 22 and an inner section 24. The outer section 22 has a first opening 26 the depth of which is about half of the thickness of the wall portion 14 of the screen 10. The inner section 24 includes a number of second openings 28 whose depth is approximately half the thickness of the wall portion 14. The apertures 18 are configured so that the second openings 28 open between the interior side 16 and the first opening 26, and the first opening 26 opens to the exterior side 15. The embodiments shown in FIGS. 1-4 have twelve second openings 28 per every first opening 26, but any number of second openings per first opening could be used.

In the embodiment shown in FIGS. 1-4, the first openings 26 are first milled to a depth of about half the thickness of the wall portion 14. The second openings 28 are then drilled into the first opening 26 through to the interior side 16. For example, the overall depth of each aperture 18 shown in FIGS. 1-4 is 0.24 inches, where the outer section 22 has a depth of 0.10 inches and the inner section 24 has a depth of 0.14 inches. The length of the first opening 26 is 0.25 inches and the width of the first opening 26 is 0.177 inches. The diameter of the second opening 28 is 0.0265 inches. These dimensions are exemplary and one skilled in the art would appreciate that a variety of other dimensions for the apertures could be used. A variety of other techniques for forming the apertures known to those skilled in the art could be used, such as, for example, milling, drilling, water jets, lasers, and EDM.

A variety of aperture configurations could be used. For example, the first openings and the second openings could be square, rectangular, oval, or a number of other shapes. As shown in FIG. 4, the apertures are substantially perpendicular to the exterior side 15 and the interior side 16. The apertures could be angled relative to the exterior side 15 and the interior side 16 as shown for example in FIG. 5. As shown in FIG. 5, the second openings 28 are angled relative to the interior side 16 and the first opening 26 is similarly angled. With the embodiment shown in FIG. 5, the direction of material flow would generally be in the direction designated by F. Alternatively, the second openings could be similarly angled and the first opening could be perpendicular relative to the exterior side 15.

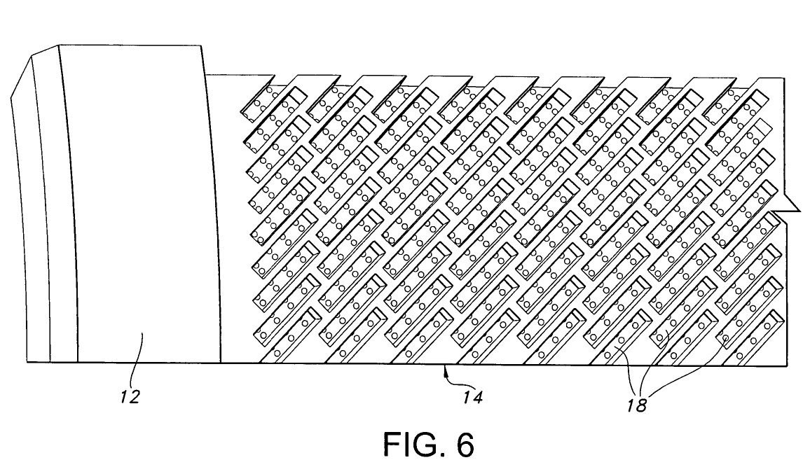

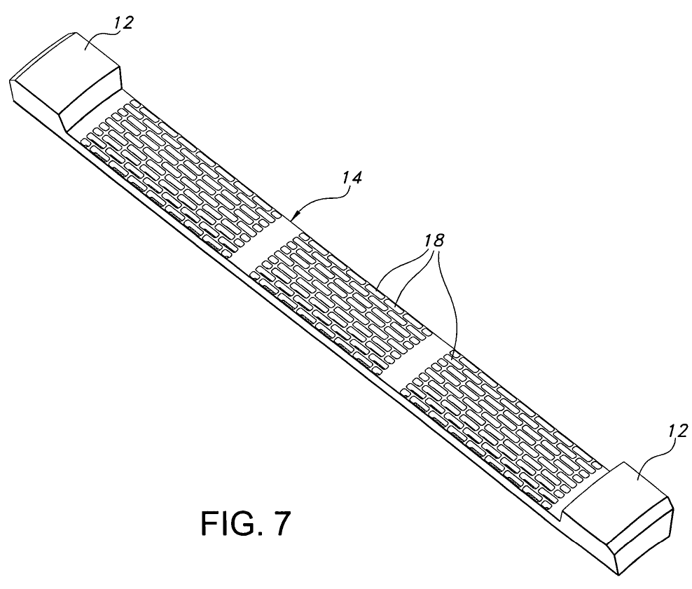

As shown in FIG. 1, the apertures in individual rows are offset from the next row and the apertures are positioned radially on the middle section. One skilled in the art would appreciate that the apertures can be position in a variety of configurations. For example, FIGS. 6 and 7 illustrate alternate embodiments of the screen. FIG. 5 is a sectional view of an alternative embodiment of the screen structure 10 wherein the apertures 18 are at an angle to the radial direction. FIG. 6 is a sectional view of a screen structure 10 wherein the apertures 18 are positioned in the axial direction. Further positioning of the apertures could be done as those skilled in the art will appreciate.

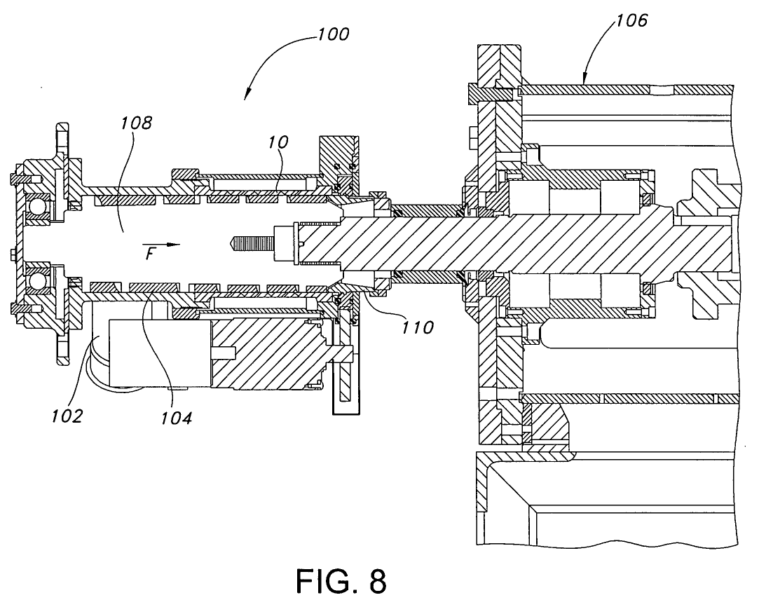

FIG. 8 illustrates cross sectional view of an example of a separation machine 100 utilizing an embodiment of the screen 10. This material is, for example, animal parts, shellfish, fruits or vegetables. The material enters the machine through an inlet tube 102. The material is received from the inlet tube into a conduit 108. On the opposite end of the conduit 108 from the inlet tube 102 is the screen 10. An auger 104 driven by a motor assembly 106 causes the material to travel in the direction F from the inlet tube 102 through the conduit 108 toward the screen 10 end of the conduit 108. As the material builds up in the screen end, the pressure increases and forces the soft material through the apertures in the screen 10. The soft material exits the machine 100 through an outlet tube (not shown). A compression ring 110 can be used to adjust the pressure and thereby control the amount of hard material that is forced out through the screen 10 by moving relative to the auger 104. Hard material is discharged from the machine in the space between the auger 104 and the compression ring 110. The separating machine 100 illustrated in FIG. 8 is a reverse flow type machine, meaning the material flows towards the motor assembly 106. Alternatively, the separating machine 100 could be a forward flow machine so that the material flows away from the motor assembly. Other devices and methods can be used to move the hard and soft material through the conduit, such as, for example, a piston, belts or the like, as is known to those skilled in the art.

There are substantial benefits associated with the separating apparatus of this invention. The separating apparatuses as described above allow for cooler operating temperatures by reducing the total pressure and total friction generated in the separating process. This decrease in pressure and temperature guarantees improved product quality by limiting the damage to product fibers and cell structure, such as, protein and fats, allowing them to remain intact resulting in a superior final product. The decrease in temperature and pressure allows for lower operating temperatures, thereby reducing the potential for bacterial growth and the cost of cooling. Separating apparatuses manufactured in accordance with this invention are easier to sanitize and clean due to the design of the apertures and the lower operating temperature thereby reducing bacterial growth.

The ease of evacuation caused by the configuration of the apertures results in an increase of flow velocity. The material under pressure moves toward low pressure. The increased rate of aperture volume expansion, versus a regular drilled hole, allows for more rapid movement of the separated product through the separating apparatus. The resulting lower total pressure requirements allows for higher operating efficiencies, lower operating temperature, greatly reduced friction, higher yield, ease of sanitation, extended component life and a finished product of superior quality.

As those skilled in the art will appreciate, the particular embodiment of this invention described above and illustrated in the figures is provided for explaining the invention, and various alterations may be made in the structure and materials of the illustrated embodiment without departing from the spirit and scope of the invention as described above and defined in the following claims.

1. A separating apparatus for use in a machine used for separating hard material from soft material, comprising:
a wall having an interior side and an exterior side; and
a plurality of apertures through the wall, each aperture comprising an outer section and an inner section, the outer section having a first opening and the inner section having a plurality of second openings, wherein the second openings open from the interior side to the first opening and the first opening opens to the exterior side.

2. The apparatus of claim 1 wherein the apparatus is a screen or sieve.

3. The apparatus of claim 1 wherein the apparatus is cylindrical in shape and further comprises two end portions.

4. The apparatus of claim 1 wherein the first opening is slot shaped, rectangular, square, oval or circular and the second opening is slot shaped, rectangular, square, oval or circular.

5. The apparatus of claim 1 wherein the apparatus is manufactured out of steel, ceramic or plastic.

6. The apparatus of claim 1 wherein the first openings are formed by milling, drilling, lasers, water jets or EDM and the second openings are formed by milling, drilling, lasers, water jets or EDM.

7. The apparatus of claim 1 wherein the second openings are substantially perpendicular relative to the interior side.

8. The apparatus of claim 1 wherein the second openings are at an acute angle relative to the interior side.

9. A machine for separating hard material from soft material, comprising:
a conduit;
an inlet tube connected to the conduit for providing the conduit with hard and soft material;
a separating apparatus positioned at one end of the conduit, the apparatus comprising a wall having an interior side and an exterior side and a plurality of apertures through the wall, each aperture comprising an outer section and an inner section, the outer section having a first opening and the inner section having a plurality of second openings, wherein the second openings open from the interior side to the first opening and the first opening opens to the exterior side; and
a device for moving the hard and soft material along the conduit from the inlet tube to the apparatus end of the conduit so that soft material and a controlled amount of hard material are forced through the apertures in the apparatus.

10. The machine of claim 9 further comprising a motor assembly for driving the device.

11. The machine of claim 10 wherein the material flows toward the motor assembly.

12. The machine of claim 10 wherein the material flows away from the motor assembly.

13. The machine of claim 9 further comprising a compression ring for controlling pressure in the conduit and allowing for the evacuation from the conduit of hard material.

14. The machine of claim 9 wherein the device is a rotating auger or a piston.

15. The machine of claim 9 wherein the apparatus is cylindrical in shape and further comprises two end portions.

16. The machine of claim 9 wherein the apparatus is a screen or a sieve.

17. A method for separating soft material from hard material, comprising
receiving hard and soft material in a conduit;
moving hard and soft material through conduit toward a portion of the conduit that has a separating apparatus;
forcing soft material and a controlled amount of hard material through the separating apparatus,
wherein the separating apparatus comprises a wall having an interior side and an exterior side and a plurality of apertures through the wall, each aperture comprising an outer section and an inner section, the outer section having a first opening and the inner section having a plurality of second openings, wherein the second openings open from the interior side to the first opening and the first opening opens to the exterior side.

18. The method of claim 17 wherein the hard and soft materials are moved through the conduit by a rotating auger.

19. The method of claim 17 wherein the apparatus is a screen or a sieve.

20. The method of claim 18 wherein the screen is cylindrical in shape and further comprises two end portions.
